(19) United States
(12) Patent Application Publication
(10) Pub. No.: US 2023/0314695 A1
(43) Pub. Date: Oct. 5, 2023

(54) MULTI-CORE OPTICAL FIBRE AND FABRICATION THEREOF

(71) Applicant: Microsoft Technology Licensing, LLC, Redmond, WA (US)

(72) Inventors: Paolo COSTA, London (GB); Gilberto BRAMBILLA, Southampton (GB); Kai SHI, Cambridge (GB); Hitesh BALLANI, Cambridge (GB); Richard James BACA, Bothell, WA (US)

(21) Appl. No.: 17/710,961

(22) Filed: Mar. 31, 2022

(51) Int. Cl. G02B 6/02; G02B 6/38

(52) U.S. Cl. CPC G02B 6/02033; G02B 6/02042; G02B 6/02361; G02B 6/3885

(57) ABSTRACT

A multi-core optical fibre comprises a plurality of cores embedded in cladding. The cladding comprises a polymer. The cladding has an outer cross-sectional shape with an order of rotational symmetry of less than or equal to 4. By limiting the rotational symmetry of the multi-core optical fibre, rotational alignment of the cores with light sources/light detectors may be made easier. Also provided are optical cables and kits including the multi-core optical fibre, and a method of fabricating a multi-core polymer optical fibre.

### BACKGROUND

An optical fibre comprises a core surrounded by cladding. In refractive index guiding fibres, the core generally has a refractive index which is greater than that of cladding. The optical fibre thus acts as a waveguide, with light being confined to the core by total internal reflection. Photonic bandgap fibres and antiresonant fibres, which achieve waveguiding by different mechanisms, have also been described.

The core and cladding each comprise optically transparent materials, generally silicates or an organic polymer such as poly(methyl methacrylate) (“PMMA”). An optical fibre in which the cladding and the core are both formed from organic polymers are referred to as “polymer optical fibres”, often abbreviated as “POF”. POFs may be cheaper to manufacture than silica-based optical fibres, and may be less fragile and easier to handle.

The boundary between the core and cladding may be an abrupt material boundary. Optical fibres with an abrupt boundary between the core and cladding are referred to as “step-index optical fibres”. Alternatively, the transition between the core and the cladding may be more gradual. Optical fibres with a gradual transition between the core and the cladding are referred to as “graded-index optical fibres”.

Optical fibres are widely used in communications systems. Data may be encoded in pulses of light which are transmitted along the optical fibres. Fibre-optic communication systems are used in a variety of contexts to transfer information, such as for telephone and internet communication, as well as for broadcasting television signals. Fibre optic communication systems are also widely used for intra-datacentre connectivity, where emerging workloads such as machine learning and resource disaggregation are significantly increasing network demands.

Optical fibres are also used in optical instruments, e.g. in boroscopes (also referred to as borescopes or fibrescopes) and endoscopes. These instruments make use of optical fibres to allow visual inspection of otherwise-inaccessible targets.

### SUMMARY

In one aspect, there is provided a multi-core optical fibre, comprising a plurality of cores embedded in cladding. The cladding comprises a polymer. The cladding has an outer cross-sectional shape with an order of rotational symmetry of less than or equal to 4. By limiting the rotational symmetry of the multi-core optical fibre, rotational alignment of the cores with light sources/light detectors may be made easier.

A related aspect provides an optical cable comprising the multi-core optical fibre and a termination connected to an end of the multi-core optical fibre. The termination has a socket which receives the end of the multi-core optical fibre, the socket having a shape which is complementary to the outer cross-sectional shape of the cladding of the multi-core optical fibre. The termination has a plug having an outer cross-sectional shape which is the same as the outer cross-sectional shape of the cladding of the multi-core optical fibre.

Another related aspect provides a kit for assembling an optical cable. The kit comprises the multi-core optical fibre and at least one termination. The termination has a socket for receiving an end of the multi-core optical fibre. The socket has a shape which is complementary to the outer cross-sectional shape of the cladding of the multi-core optical fibre. The termination has a plug having an outer cross-sectional shape which is the same as the outer cross-sectional shape of the cladding of the multi-core optical fibre.

A further aspect provides a method of fabricating a multi-core polymer optical fibre. The method comprises forming a plurality of cores; and forming cladding around the plurality of cores. The cladding comprises a polymer. The cladding has an outer cross-sectional shape with an order of rotational symmetry of less than or equal to 4.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic cross-section of a comparative multi-core optical fibre;

FIG. 2 is a schematic cross-section of a first example multi-core optical fibre;

FIG. 3 is a schematic cross-section of a second example multi-core optical fibre;

FIG. 4 is a schematic perspective view of an example kit for assembling an optical cable; and

FIG. 5 is a flow diagram outlining an example method of fabricating a multi-core optical fibre.

### DETAILED DESCRIPTION

The verb ‘to comprise’ is used herein as shorthand for ‘to include or to consist of’. In other words, although the verb ‘to comprise’ is intended to be an open term, the replacement of this term with the closed term ‘to consist of’ is explicitly contemplated, particularly where used in connection with chemical compositions.

Directional terms such as “top”, “bottom”, “left”, “right”, “above”, “below”, “horizontal” and “vertical” are used herein for convenience of description and relate to the orientation illustrated in the relevant Fig. of the drawings. For the avoidance of any doubt, this terminology is not intended to limit orientation in an external frame of reference.

Geometrical terms such as “triangular”, “square”, and “hexagonal”, are used herein for convenience of description. As will be appreciated, shapes of components may vary within manufacturing tolerances.

The term “polymer” is used herein as shorthand for “organic polymer”. Silicates are not considered to be polymers in the present context.

A “multi-core” optical fibre is an optical fibre including at least two cores, often ten or more cores.

All “cross-sections” are taken perpendicular to the length of the direction of the optical fibre or optical fibre preform, unless otherwise stated. The length direction is the direction in which the optical fibre preforms will be drawn, and in which light will propagate along the optical fibre.

For optical fibres which are not circular in cross-section, the “centre” is taken to be the geometric centre (also referred to as a “centroid”) when viewed in cross-section, and the “radius” is taken to be the longest straight line from the centre to the outer edge of the cladding.

Attenuation, also referred to as transmission loss, is the reduction in intensity of a light beam as a function of distance travelled through the optical fibre. In a fibre optic communication system, attenuation constrains the maximum length of the optical fibre, the minimum transmitter power, and the minimum detector sensitivity.

One challenge encountered when handling conventional optical fibres is that the cylindrical shape of the optical fibres makes it hard to keep the fibres in place. This problem is exacerbated for multi-core optical fibres, which require rotational alignment as well as horizontal and vertical alignment. Alignment tolerances are small, with a misalignment of 0.1 Linn potentially reducing signal strength by 30%.

Installing conventional multi-core optical fibres usually requires active alignment of the fibres. Active alignment is a delicate and time-consuming process, in which light is coupled into one end of the fibre to allow an optimal position of a component at the other end of the fibre to be identified. Conventional multi-core optical fibres may suffer from poor reliability if subjected to vibrations, for example.

Described herein are multi-core optical fibres having outer cladding formed of an organic polymer, rather than silica glass. The shape of the outer cladding is controlled in order to make the fibre easier to align and package. By using polymer cladding of a defined shape, passive alignment techniques may be used to install the fibre, and the fibre may be cut and connectorized in the field without requiring specialised equipment.

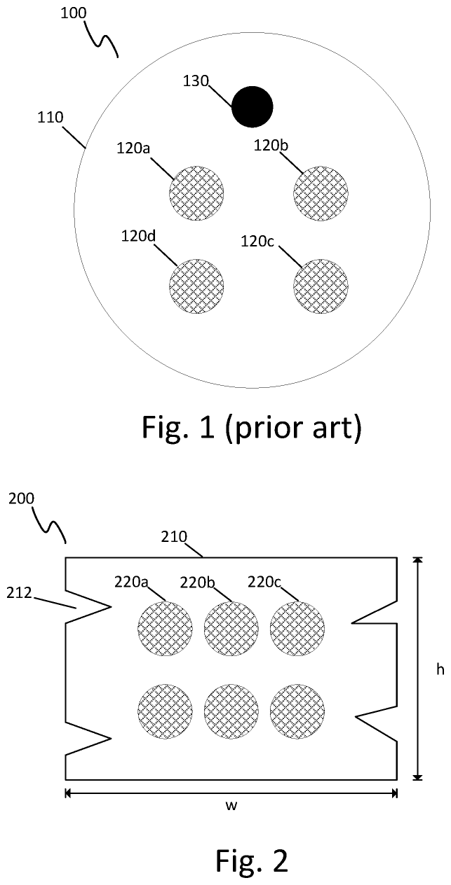

A comparative multi-core optical fibre 100 is illustrated in FIG. 1. The multi-core optical fibre 100 comprises a plurality of cores 120a, 120b, 120c, 120d embedded in cladding 110. The cladding 110 and cores 120 comprise silica glass. The cladding 110 has a circular outer cross-section. Drawing processes used to produce silica fibres cause the silica fibres to adopt circular shapes.

A borehole 130 is provided in the cladding. The borehole 130 is offset from the centre of the optical fibre. In use, the borehole 130 receives a pin arranged on a device to which the optical fibre connects. The borehole 130 may assist with positioning the optical fibre during an active alignment process. The alignment of an optical fibre may be conveniently described using a cylindrical polar coordinate system. The borehole 130 may help with aligning the longitudinal axis of the fibre with the longitudinal axis of the device. However, the borehole 130 does not assist with alignment in the azimuthal direction. Even if the longitudinal axes are correctly aligned, a rotational offset between the cores transmitters/receivers of the device may remain. Active alignment of the cores 120 of the optical fibre 100 during installation therefore remains necessary.

In addition, forming the borehole 130 complicates fabrication of the optical fibre 100.

An example multi-core optical fibre 200 will now be described with reference to FIG. 2. FIG. 2 is a schematic cross-section of the multi-core optical fibre.

The multi-core optical fibre 200 comprises a plurality of cores 220a, 220b, 220c embedded in cladding 210.

The cores comprise an optically transparent material having a refractive index which is higher than that of the cladding. This allows for propagation of light signals along the length of the fibre by total internal reflection.

The nature of the cores is otherwise not particularly limited. The cores may be polymer cores or silica fibres. The cores may be solid cores. Alternatively, the cores may be microstructured cores. A microstructured core includes a pattern of holes for modifying the refractive index of the core. In accordance with a still further possibility, the cores may be cavities surrounded by curved thin polymer membranes, allowing for propagation of light signals along the length of the fibre by antiresonant guidance.

Polymer cores typically comprise an organic thermoplastic polymer. Illustrative examples of organic polymers useful for forming cores of polymer optical fibres include polyacrylates, such as poly(methyl methacrylate); polyethylene; polystyrenes; polycarbonates; poly(perfluorobutylene vinyl ether); and cyclic olefin copolymers.

Optical fibres with polymer cores may be easier to install than those with silica cores. A polymer optical fibre may be cut to length using an ordinary blade, cable cutter or the like. Typically, cutting a polymer optical fibre will not generate sharp fragments.

Organic polymers typically have melting points which are significantly lower than the melting point of silica. For example, poly(methyl methacrylate) may melt at a temperature of about 160° C., whereas the melting point of silica is about 1,170° C. Polymer fibres may be produced by lower-cost manufacturing processes than silica fibres.

Optical fibres with silica cores may have favourable optical properties. Cutting an optical fibre with a silica core may comprise weakening the fibre with a diamond-edged scribe, or the use of a specifically designed cleaving device.

The core may include a dopant for modifying the refractive index of the core, particularly in implementations where the cores are polymer cores.

The cores 220 are embedded in cladding 210. The cladding comprises an organic polymer. Examples of organic polymers useful for forming cladding include halogenated polymers, such as fluoropolymers and chloropolymers. Fluoropolymers typically have a lower refractive indices than chloropolymers. Examples of useful fluoropolymers include poly(fluoroalkyl methacrylate), poly(vinylidene fluoride), and poly(perfluoro-butenylvinyl ether).

The cladding 210 may be doped with a dopant for modifying the refractive index of the cladding. Examples of dopants for the cladding 210 include oligomers, in particular chlorinated or fluorinated oligomers.

The cladding 210 is configured such that the outer cross-section of the optical fibre 200, defined by the outer edge of the cladding 210, has a low order of rotational symmetry. A low order of rotational symmetry in this context is an order of rotational symmetry of less than or equal to 4. By restricting the order of rotational symmetry of the cladding, rotational alignment of the optical fibre may be made easier. The optical fibre may be configured to fit in a socket in only a small finite number of possible orientations, most preferably in only one orientation.

In this example, the cladding 210 has an outer cross-sectional shape based on a rectangle of width w and height h. The width and height are not equal. The aspect ratio of the rectangle, i.e. the ratio of the width w to the height may be in the range 2:1 to 4:1, and may be for example 3:1. Optical fibres with generally rectangular cross-sections may be particularly easy to align.

The outer cross-section of cladding 210 includes a plurality of notches or grooves 212. In this example, two opposed sides of the cladding 210 are provided with two respective V-shaped notches. The notches may be configured to reduce the rotational symmetry of the outer cross-section. Individual sides of the cladding 210 may have unique configurations of notches. The number, shape, size, and relative position(s) of notches in each side of the cladding may be different in order to distinguish different sides from one another. The notches may be configured to reduce the order of rotational symmetry to 1.

Various modifications may be made to the illustrated optical fibre.

The illustrated optical fibre has six circular cores. The number of cores is not particularly limited and may be selected as appropriate. The cores may have any appropriate shape, particularly in implementations where the cores are polymer cores. Polymer cores of arbitrary shape may be readily manufactured by extrusion through an appropriate die.

A sharp boundary between the cores and cladding is shown in the drawings for ease of representation. In a step-index multi-core optical fibre, a sharp material boundary between the core and cladding may indeed be present. In a graded-index multi-core optical fibre, there may be a continuous transition between the core and cladding. For example, the difference between the materials of the core and cladding may be the concentration of a dopant. The dopant may be distributed on a concentration gradient.

The illustrated example has a single layer of cladding. Two or more layers of cladding, which may comprise different cladding materials, may be present. Where multiple layers of cladding are present, at least the outermost layer has the low order of rotational symmetry.

The illustrated optical fibre has four notches, arranged on two opposite sides of the cladding. Any number of notches may be present, and the notches may be distributed on any side of the optical fibre. The inclusion of one or more notches is not essential, and the notches may be omitted.

The optical fibre may include additional components, such as a jacket surrounding the cladding. When one or more such additional components are present, the additional components are configured such that the outer cross-sectional shape of the optical fibre has the low order of rotational symmetry. The additional components typically have the same cross-sectional shape as that of the cladding.

The example of FIG. 2 has an outer cross-sectional shape based on a rectangle. Many other configurations are possible. The outer cross-sectional shape is not particularly limited, provided that the outer cross-sectional shape has a low order of rotational symmetry.

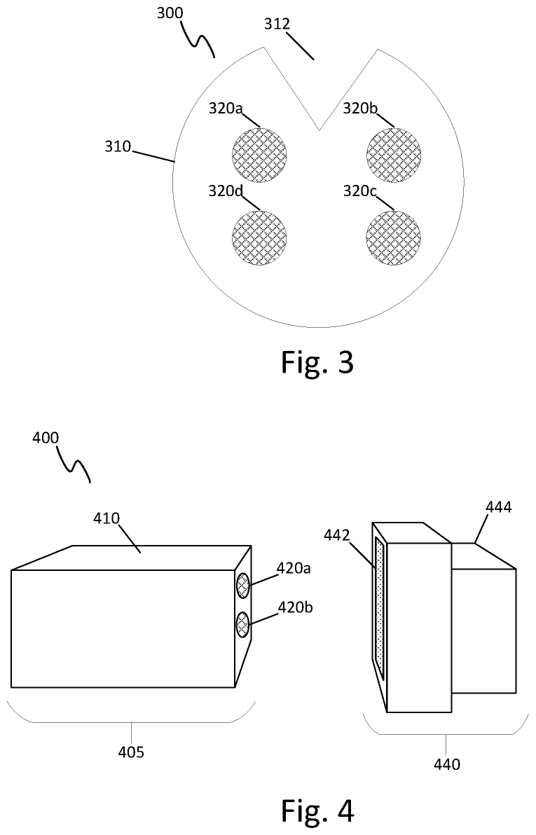

One alternative configuration is illustrated in FIG. 3, which shows a further example of a multi-core optical fibre 300.

Multi-core optical fibre 300 comprises a plurality of cores 320a, 320b, 320c, 320d embedded in cladding 310. The cores may be as previously described with reference to FIG. 2. Cladding 310 comprises an organic polymer, again as previously described. In this example, cladding 310 has an outer-cross sectional shape which is based on a circle. The outer-cross section of cladding 310 includes a notch 312. The notch reduces the order of rotational symmetry of the outer cross section from infinity to the lowest possible, 1.

The example notch 312 is V-shaped. It will be appreciated that the shape of any notch(es) is not particularly limited and may be selected as appropriate.

Alternatives to notches may be used to reduce the order of rotational symmetry of a given shape. For example, notch 312 may be replaced by a flat side, forming a D-shape.

The optical fibres described herein may be assembled into optical cables by adding a termination to at least one end of the optical fibre. A schematic perspective view of an example kit 400 for assembling an optical cable is illustrated in FIG. 4.

The example kit 400 includes an optical fibre 405 and a termination 440 for the optical fibre.

The optical fibre 405 comprises a plurality of cores 420a, 420b embedded in cladding 410. The cladding 410 has an outer cross-sectional shape with a low order of rotational symmetry. In this example, the outer cross-section of the cladding 410 is rectangular.

The termination 440 comprises a socket 442 at one end and a plug 444 at an opposite end. The socket 442 is configured to receive an end of the optical fibre 405. The plug may have the same outer cross-sectional shape as that of the cladding. The termination may be configured as a hollow tube-like member.

In use, the end of the optical fibre 405 is inserted into socket 442 of termination 440. The end of the optical fibre 405 may extend through the termination to the plug 444. The termination may be fixed to the optical fibre by a friction fit or by an adhesive. The plug 444 is then inserted into a socket on a device. The termination may provide mechanical support to the end of the optical fibre, reducing bending of the optical fibre at the point where the optical fibre connects to a device.

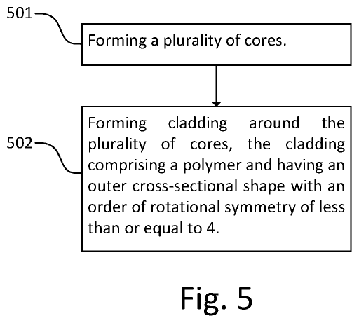

An example method of fabricating a multi-core polymer optical fibre will now be described with reference to FIG. 5. FIG. 5 is a flow diagram outlining the method.

At block 501, a plurality of cores is formed.

The technique used to form the cores may be selected as appropriate based on the nature of the cores.

Forming the plurality of cores may comprise forming a plurality of silicate cores, for example by drawing silicate fibres.

Alternatively, forming the plurality of cores may comprise forming a plurality of polymer cores. Polymer cores may be formed by various different techniques, for example by extrusion or 3D printing.

At block 502, cladding is formed around the plurality of cores. The cladding comprises a polymer. The cladding has an outer cross-sectional shape with an order of rotational symmetry of less than or equal to 4.

Cladding having a cylindrical outer cross-sectional shape may be formed, and may then be cut to the desired shape. More preferably, cladding having the target outer cross-sectional shape may be formed in a single operation, for example by extrusion through a die having an aperture of the desired shape. This may allow for faster and/or more reliable preparation of the cladding.

Alternatively, cladding of a desired target shape may be formed by 3D printing.

In implementations where the core and cladding are both formed using the same technique, the operations of blocks 501 and 502 may be performed simultaneously. For example, the core and cladding may be formed by co-extrusion.

The method may be implemented as a continuous processes, in which an optical fibre is manufactured directly from raw materials; or as a discontinuous processes, in which the optical fibre is manufactured from a preform.

An optical fibre preform is an intermediate product. An optical fibre preform comprises a core and cladding surrounding the core. An optical fibre preform has a thickness which is greater than that of a finished optical fibre, and a length which is less than that of a finished optical fibre. By way of illustration, an optical fibre preform may have a thickness of greater than or equal to 2 cm, e.g. 2 to 30 cm, and a length of less than 300 cm, e.g. 30 to 300 cm. In contrast, an optical fibre may have a thickness of less than or equal to 1 mm and a length of 1 m or more.

In a discontinuous implementation, forming the cores and forming the cladding around the cores may comprise manufacturing optical fibre preforms, e.g. by co-extrusion. A plurality of optical fibre preforms may then be stacked together, and drawn and bonded to form the multi-core optical fibre. Discontinuous processes are most applicable to polymer-core fibres.

Drawing and bonding the stack may comprise heating the stack to soften the cores and the cladding, and tensioning the softened stack. This stretches the preforms, increasing their length while reducing their thickness. At the same time, adjacent preforms are forced towards one another. Since the cladding is in a softened state, adjacent preforms become fusion bonded. This yields a multi-core polymer optical fibre having a plurality of cores held together by a unitary portion of cladding material.

The outer cross-sectional shape of the finished multi-core optical fibre may be controlled by controlling the shape of the preforms.

The optical fibre preforms may have a tileable shape when viewed end-on. When viewed in a cross-section taken perpendicular to the length direction of the core, the outermost edges of the optical fibre preform may form a tileable shape. In other words, the cladding may have a stackable outer geometry.

A “tileable” shape is a polygonal shape which allows the preforms to be stacked together without gaps between preforms in the stack. In other words, a tileable shape is a shape which tessellates. Illustrative examples of tileable shapes include triangles, squares, rectangles, and hexagons. Rectangular preforms may conveniently be used to form a rectangular multi-core optical fibre.

The surfaces of the optical fibre preforms may collect particulate matter, e.g. dust or dirt, before the drawing and bonding process. In the finished multi-core optical fibre, the portion of the cladding which is immediately adjacent to the cores may be substantially free of the particulate matter, with the particulate matter being concentrated far away from the cores, at the locations of the former boundaries between the preforms. Consequently, the particulate matter has very little impact on signals passing through a core. However, light passing between cores may be attenuated by the particulate matter. The particulate matter may thus reduce crosstalk between adjacent signal paths.

Drawing processes may tend to circularise the outer cross-sectional shape. This may be avoided by rapid cooling of the newly-drawn optical fibre, and/or by drawing the optical fibre through a die having an aperture of the desired shape.

A discontinuous process is discontinuous in the sense that the manufacture of the preform and the fibre drawing may be performed at different times, and using different apparatuses. The preform may be processed, stored, and/or transported after manufacture and before fibre drawing.

A continuous process is one which forms the multi-core optical fibre directly, without manufacturing preforms. One example of a continuous process is the co-extrusion of the cores and cladding.

The described processes may be used to fabricate step-index optical fibres or graded-index optical fibres. One example route to a graded-index polymer optical fibre is to include a dopant in one of the cladding and the core, and to cause diffusion of the dopant into the other of the cladding and the core. The diffusion is stopped before equilibration occurs, such that the dopant is distributed on a continuous concentration gradient.

Causing the diffusion typically comprises heating the core and cladding to an elevated temperature at which the core and cladding soften. The core and cladding are maintained at the elevated temperature for a period of time to generate the concentration gradient. The core and cladding are then cooled to cause them to solidify, thereby stopping the diffusion and preventing the concentration of dopant from equilibrating. The extent to which the dopant diffuses may be controlled by varying the temperature and/or the duration of the period of time.

It will be appreciated that the above embodiments have been described by way of example only.

More generally, according to one aspect disclosed herein, there is provided a multi-core optical fibre. The multi-core optical fibre comprises a plurality of cores embedded in cladding. The cladding comprises a polymer. The cladding has an outer cross-sectional shape with an order of rotational symmetry of less than or equal to 4. The shape of polymer cladding may be readily controlled, for example by extruding the cladding through an aperture having a selected shape. By limiting the rotational symmetry of the multi-core optical fibre, rotational alignment of the cores with light sources/light detectors may be made easier.

The cladding may have an order of rotational symmetry of 4, 3, 2, or 1. In particular, the cladding may have an outer cross-sectional shape with an order of rotational symmetry of 1.

The cladding may be free of boreholes. A borehole is a hole which extends into the cladding in the length direction of the optical fibre. Avoiding the inclusion of boreholes may reduce manufacturing costs.

Provided that the outer cross-sectional shape of the cladding has a low order of rotational symmetry, the outer cross-sectional shape is not particularly limited. For example, the outer cross-sectional shape may be square or rectangular.

The outer cross-sectional shape may include one or more notches. Providing one or more notches or grooves may allow the order of rotational symmetry of a given shape to be reduced. For example, adding one notch, groove, or a flat side to a circular shape reduces the order of rotational symmetry from infinity to one.

Where one or more notches or grooves are present, the notches or grooves may be configured to receive a complementary projection on a socket or termination. This may be useful for holding the optical fibre in position.

The cores of the multi-core optical may be silica cores. Alternatively, the cores may be polymer cores.

The multi-core optical fibre may be step-index or graded-index.

A graded-index multi-core optical fibre may include a dopant. The dopant may be distributed on a continuous concentration gradient, according to which concentration gradient the concentration of the dopant increases with distance from the centre of the core. Such an optical fibre may be obtained by doping the cladding, and then causing diffusion of the dopant into the core from the cladding. Each core of the plurality of cores may comprise a central region and an outer region surrounding the central region, with the central region consisting of a core polymer and the outer region comprising the core polymer and dopant. Dopants and other impurities contribute to the attenuation of the optical fibre. Doping the cladding and diffusing dopant into the core from the cladding may reduce the attenuation of the optical fibre by minimising the amount of dopant present in the core. The most heavily doped parts of the optical fibre, the outer portions of the cladding, are also the parts which interact with the least amount of the light signal.

The multi-core optical fibre may further comprise particulate material embedded in the cladding. Each of the cores may be surrounded by respective first and second regions of cladding. The first region may be free of the particulate material. The second region may be spaced from the core by the first region, and may include the particulate material. At least part of the second region may be arranged between the core and one or more adjacent cores. In particular, multi-core optical fibres obtained by stacking and drawing preforms may include particulate matter. The surfaces of the optical fibre preforms may collect particulate matter, e.g. dust or dirt, before being drawn and bonded. Particulate matter scatters light. If the particulate matter is localised in areas which are between the cores and spaced from the cores, the particulate matter may reduce crosstalk between adjacent cores while having little impact on signals propagating within individual cores.

A related aspect provides an optical cable which comprises the multi-core optical fibre and a termination connected to an end of the multi-core optical fibre. The termination has a socket which receives the end of the multi-core optical fibre, the socket having a shape which is complementary to the outer cross-sectional shape of the cladding of the multi-core optical fibre. The termination has a plug having an outer cross-sectional shape which is the same as the outer cross-sectional shape of the cladding of the multi-core optical fibre. Terminations may be provided at both ends of the optical cable.

Also provided is a kit for assembling the optical cable. The kit comprises a multi-core optical fibre as described herein and at least one termination. The termination has a socket for receiving an end of the multi-core optical fibre. The socket has a shape which is complementary to the outer cross-sectional shape of the cladding of the multi-core optical fibre. The termination has a plug having an outer cross-sectional shape which is the same as the outer cross-sectional shape of the cladding of the multi-core optical fibre.

In another aspect, there is provided a method of fabricating a multi-core polymer optical fibre as described herein. The method comprises forming a plurality of cores, and forming cladding around the plurality of cores. The cladding comprises a polymer. The cladding has an outer cross-sectional shape with an order of rotational symmetry of less than or equal to 4.

The method may implement any of the features described above with reference to the multi-core optical fibre. For example, the cladding may have an outer cross-sectional shape with an order of rotational symmetry of 1. The outer cross-sectional shape may include one or more notches.

The cladding may be formed by extruding the polymer through a die, the die having an opening with the outer cross-sectional shape. Extrusion may allow for the rapid and straightforward formation of cladding having a desired shape.

The multi-core optical fibre may be manufactured by co-extrusion of the cores and cladding in a continuous process. In such implementations, the cores and cladding are formed simultaneously.

Alternatively, multi-core optical fibre may be manufactured by a discontinuous process. For example, forming the plurality of cores and forming the cladding may comprise forming a plurality of optical fibre preforms. In such implementations, the method further comprises forming a stack of the optical fibre preforms; and drawing and bonding the stack to form the multi-core optical fibre. The cores and cladding of the preforms may be formed by, for example, co-extrusion or 3D printing.

The optical fibre preforms may have tileable outer cross-sectional shapes. By “tileable” is meant that the outer cross-sectional shapes of the optical fibre preforms are configured to allow the optical fibre preforms to be stacked together without gaps between the preforms. For example, the outer cross-sectional shapes of the optical fibre preforms may be selected from triangular, rectangular, square, and hexagonal. Stacking tileable preforms may allow for reliable positioning of the cores in the multi-core optical fibre. Controlling the shapes of the preforms is one technique which may be used to control the shape of the optical fibre.

The cores may be polymer cores. In such implementations, the cores and cladding may be formed by co-extrusion. The co-extrusion may form optical fibre preforms as part of a discontinuous fabrication process. Alternatively, co-extrusion may be used to form the optical fibre directly, in a continuous process.

When the cores are polymer cores, the cladding may include a dopant. The method may further comprise causing diffusion of the dopant from the cladding into the cores. This may allow a graded-index multi-core polymer optical fibre to be obtained. Doping the cladding and causing diffusion of the dopant from the cladding into the core may minimize the amount of dopant present in the core. This may reduce the attenuation of the optical fibre.

Also provided herein is a method of connecting a multi-core optical fibre to a device. The multi-core optical fibre may be any of the multi-core optical fibres defined herein. The multi-core optical fibre comprises a plurality of cores embedded in cladding. The cladding comprises a polymer and having an outer cross-sectional shape with an order of rotational symmetry of less than or equal to 4. The device includes a socket having a shape complementary to the outer-cross sectional shape of the multi-core optical fibre. The method comprises rotating the multi-core optical fibre to align an end of multi-core optical fibre with the socket, and inserting the end of the multi-core optical fibre into the socket. Since the multi-core optical fibre and socket have low orders of rotational symmetry, aligning the end of the optical fibre with the socket aligns the cores of the optical fibre azimuthally with optical transmitters and/or optical receivers of the device.

Connecting the multi-core optical fibre to the device may therefore simultaneously achieve alignment of the cores of the multi-core optical fibre with the device. In other words, the method provides passive alignment of the cores. The method may be free of any active alignment process.

A related aspect provides a method of aligning two or more multi-core optical fibres. Each of the multi-core optical fibres is as defined hereinabove, and comprises a plurality of cores embedded in cladding, the cladding comprising a polymer and having an outer cross-sectional shape with an order of rotational symmetry of less than or equal to 4. The outer cross-sectional shapes of the two or more multi-core optical fibres are the same. The method comprises rotating the multi-core optical fibres to align the outer cross-sectional shapes of the multi-core optical fibres with one another. Aligning the outer-cross-sectional shapes aligns the cores of the respective fibres in an azimuthal direction.

The present disclosure provides the following clauses:

Clause 1. A multi-core optical fibre, comprising a plurality of cores embedded in cladding, wherein:
the cladding comprises a polymer; and
the cladding has an outer cross-sectional shape with an order of rotational symmetry of less than or equal to 4.
   Clause 2. The multi-core optical fibre according to Clause 1, wherein the cladding has an outer cross-sectional shape with an order of rotational symmetry of 1.
   Clause 3. The multi-core optical fibre according to Clause 1 or Clause 2, wherein the cladding is free of boreholes.
   Clause 4. The multi-core optical fibre according to any preceding Clause, wherein the outer cross-sectional shape includes one or more notches.
   Clause 5. The multi-core optical fibre according to any preceding Clause, wherein the cores are polymer cores.
   Clause 6. The multi-core optical fibre according to any preceding Clause, which is a graded-index optical fibre.
   Clause 7. The multi-core optical fibre according to Clause 6, wherein each core of the plurality of cores is surrounded by cladding, the core and cladding including a dopant, the dopant being distributed on a continuous concentration gradient, according to which concentration gradient the concentration of the dopant increases with distance from the centre of a core.
   Clause 8. The multi-core optical fibre according to Clause 7, wherein:
each core of the plurality of cores comprises a central region and an outer region surrounding the central region;
the central region consisting of a core polymer;
the outer region comprising the core polymer and dopant.
   Clause 9. The multi-core optical fibre according to any preceding Clause, further comprising particulate material embedded in the cladding, wherein:
each of the cores is surrounded by respective first and second regions of cladding,
   the first region being free of the particulate material,
   the second region being spaced from the core by the first region,
   the second region including the particulate material, and
   at least part of the second region being arranged between the core and one or more adjacent cores.
      Clause 10. An optical cable comprising:
a multi-core optical fibre according to any preceding Clause; and
a termination connected to an end of the multi-core optical fibre;
wherein the termination has a socket which receives the end of the multi-core optical fibre, the socket having a shape which is complementary to the outer cross-sectional shape of the cladding of the multi-core optical fibre; and
wherein the termination has a plug having an outer cross-sectional shape which is the same as the outer cross-sectional shape of the cladding of the multi-core optical fibre.
   Clause 11. A kit for assembling an optical cable, which kit comprises:
a multi-core optical fibre according to any of Clauses 1 to 9; and
at least one termination;
wherein the termination has a socket for receiving an end of the multi-core optical fibre, the socket having a shape which is complementary to the outer cross-sectional shape of the cladding of the multi-core optical fibre; and
wherein the termination has a plug having an outer cross-sectional shape which is the same as the outer cross-sectional shape of the cladding of the multi-core optical fibre.
   Clause 12. A method of fabricating a multi-core polymer optical fibre, which method comprises:
forming a plurality of cores; and
forming cladding around the plurality of cores;
   wherein the cladding comprises a polymer, and wherein the cladding has an outer cross-sectional shape with an order of rotational symmetry of less than or equal to 4.
   Clause 13. The method according to Clause 12, wherein the cladding has an outer cross-sectional shape with an order of rotational symmetry of 1.
   Clause 14. The method according to Clause 12 or Clause 13, wherein the outer cross-sectional shape includes one or more notches.
   Clause 15. The method according to any of Clauses 12 to 14, wherein the cladding is formed by extruding the polymer through a die, the die having an opening with the outer cross-sectional shape.
   Clause 16. The method according to any of Clauses 12 to 14, wherein:
forming the plurality of cores and forming the cladding comprises forming a plurality of optical fibre preforms;
and wherein the method further comprises:
forming a stack of the optical fibre preforms; and
drawing and bonding the stack to form the multi-core polymer optical fibre.
   Clause 17. The method according to Clause 16, wherein the optical fibre preforms have tileable outer cross-sectional shapes.
   Clause 18. The method according to any of Clauses 12 to 17, wherein the cores are polymer cores.
   Clause 19. The method according to any of Clauses 12 to 18, wherein the cores and cladding are formed by co-extrusion.
   Clause 20. The method according to any of Clause 12 to 19, wherein the cladding includes a dopant, and wherein the method further comprises causing diffusion of the dopant from the cladding into the cores.
   Clause 21. A method of connecting a multi-core optical fibre to a device,
wherein the multi-core optical fibre comprises a plurality of cores embedded in cladding, the cladding comprising a polymer and having an outer cross-sectional shape with an order of rotational symmetry of less than or equal to 4;
wherein the device includes a socket having a shape complementary to the outer-cross sectional shape of the multi-core optical fibre;
   which method comprises:
rotating the multi-core optical fibre to align an end of multi-core optical fibre with the socket, whereby aligning the end of the optical fibre with the socket aligns the cores of the optical fibre azimuthally with optical transmitters and/or optical receivers of the device; and
inserting the end of the multi-core optical fibre into the socket.
   Clause 22. A method of aligning two or more multi-core optical fibres,
wherein each of the multi-core optical fibres comprises a plurality of cores embedded in cladding, the cladding comprising a polymer and having an outer cross-sectional shape with an order of rotational symmetry of less than or equal to 4;
wherein the outer cross-sectional shapes of the two or more multi-core optical fibres are the same;
the method comprising:
rotating the multi-core optical fibres to align the outer cross-sectional shapes of the multi-core optical fibres with one another;
whereby aligning the outer cross-sectional shapes aligns the cores of the respective fibres in an azimuthal direction.

Other variants or use cases of the disclosed techniques may become apparent to the person skilled in the art once given the disclosure herein. The scope of the disclosure is not limited by the described embodiments but only by the accompanying claims.

1. A multi-core optical fibre comprising:
cores embedded in cladding,
the cladding comprising a polymer,
the cladding comprising particulate matter at a location of a former boundary between adjacent optical fibre preforms,
the cladding having an outer cross-sectional shape with an order of rotational symmetry of less than or equal to 4.

2. The multi-core optical fibre according to claim 1, wherein the cladding has an outer cross-sectional shape with an order of rotational symmetry of 1.

3. The multi-core optical fibre according to claim 1, wherein the cladding is free of boreholes.

4. The multi-core optical fibre according to claim 1, wherein the outer cross-sectional shape includes one or more notches.

5. The multi-core optical fibre according to claim 1, wherein the cores are polymer cores.

6. The multi-core optical fibre according to claim 1, which is a graded-index optical fibre.

7. The multi-core optical fibre according to claim 1, wherein each core of the cores is surrounded by the cladding, the core and cladding including a dopant, the dopant being distributed on a continuous concentration gradient, according to which concentration gradient the concentration of the dopant increases with distance from a centre of the core.

8. The multi-core optical fibre according to claim 1, wherein:
each of the cores comprises a central region and an outer region surrounding the central region;
the central region consisting of a core polymer;
the outer region comprising the core polymer and a dopant.

9. The multi-core optical fibre according to claim 1, wherein:
each of the cores is surrounded by respective first and second regions of cladding,
the first region being free of particulate material,
the second region being spaced from the core by the first region,
the second region including the particulate material, and
at least part of the second region being arranged between the core and one or more adjacent cores.

10. An optical cable comprising:
a multi-core optical fibre according to claim 1; and
a termination connected to an end of the multi-core optical fibre;
wherein the termination has a socket which receives the end of the multi-core optical fibre, the socket having a shape which is complementary to the outer cross-sectional shape of the cladding of the multi-core optical fibre; and
wherein the termination has a plug having an outer cross-sectional shape which is the same as the outer cross-sectional shape of the cladding of the multi-core optical fibre.

11. A kit for assembling an optical cable, which kit comprises:
a multi-core optical fibre according to claim 1; and
at least one termination;
wherein the termination has a socket for receiving an end of the multi-core optical fibre, the socket having a shape which is complementary to the outer cross-sectional shape of the cladding of the multi-core optical fibre; and
wherein the termination has a plug having an outer cross-sectional shape which is the same as the outer cross-sectional shape of the cladding of the multi-core optical fibre.

12. A method of fabricating a multi-core optical fibre, which method comprises:
forming cores;
forming cladding around the cores; and
causing particulate matter to be embedded in the cladding,
wherein the cladding comprises a polymer, and
wherein the cladding has an outer cross-sectional shape with an order of rotational symmetry of less than or equal to 4.

13. The method according to claim 12, wherein the cladding has an outer cross-sectional shape with an order of rotational symmetry of 1.

14. The method according to claim 12, wherein the outer cross-sectional shape includes one or more notches.

15. The method according to claim 12, wherein the cladding is formed by extruding the polymer through a die, the die having an opening with the outer cross-sectional shape.

16. The method according to claim 15, wherein the cores and cladding are formed by co-extrusion.

17. The method according to claim 12, wherein:
forming the cores and forming the cladding comprise forming optical fibre preforms; and
wherein the method further comprises:
forming a stack of the optical fibre preforms; and
drawing and bonding the stack to form the multi-core optical fibre.

18. The method according to claim 17, wherein the optical fibre preforms have tileable outer cross-sectional shapes.

19. The method according to claim 17, wherein the cores are polymer cores.

20. (canceled)

21. A method comprising:
forming cores of a multi-core optical fibre; and
forming cladding around the cores resulting in the cladding comprising particulate matter arranged between adjacent cores,
wherein the cladding comprises a polymer, and
wherein the cladding has an outer cross-sectional shape with an order of rotational symmetry of less than or equal to 4.
